(19) United States
(12) Patent Application Publication
(10) Pub. No.: US 2026/0341841 A1
(43) Pub. Date: Oct. 29, 2026

(54) BATTERY SYSTEM AND AN ELECTRIC VEHICLE INCLUDING THE BATTERY SYSTEM

(71) Applicant: Samsung SDI Co., Ltd., Yongin-si (KR)

(72) Inventors: Wolfgang REINPRECHT, Attendorf (AT); Stefan REINPRECHT, Attendorf (AT)

(21) Appl. No.: 19/634,042

(22) Filed: Mar. 30, 2026

(30) Foreign Application Priority Data
Apr. 24, 2025 (EP) 25172125.4

(51) Int. Cl. H01M 10/6566; B60L 3/00; H01M 10/613; H01M 10/625; H01M 10/6556; H01M 50/358

(52) U.S. Cl. CPC H01M 10/6566; B60L 3/0046; H01M 10/613; H01M 10/625; H01M 10/6556; H01M 50/358; H01M 2220/20

(57) ABSTRACT

The present disclosure refers to a battery system and a vehicle including the battery system. The battery system includes a battery pack including a housing, a floor, and a plurality of battery cells within the housing above the floor, an underbody protection plate located below the floor, and spaced apart from the floor such that an enclosed space is formed between the underbody protection plate and the floor, the enclosed space including at least one inlet fluidly connected to the housing and an outlet leading out of the battery system, the outlet being located in a central area of the underbody protection plate, and a plurality of baffles extending between the underbody protection plate and the floor, and being configured, between the inlet and the outlet, to direct venting products exhausted by at least one of the battery cells to the outlet.

### CROSS REFERENCE TO RELATED APPLICATION

The present application claims priority to and the benefit of European Patent Application No. 25172125.4, filed on Apr. 24, 2025, in the European Patent Office, the entire disclosure of which is incorporated herein by reference.

### BACKGROUND

### 1. Field

Aspects of embodiments of the present disclosure relate to a battery system. The present disclosure also relates to an electric vehicle including the battery system.

### 2. Description of the Related Art

A battery pack (e.g., a battery pack of a battery system) is a set of any number of battery modules or single battery cells (e.g., identical battery modules or identical single battery cells). The battery modules and/or their respective battery cells, may be configured in a series, parallel, or a series/parallel connection configuration to provide a desired voltage, capacity, and/or power density. Components of a battery pack may include the individual battery modules, and interconnects, which may provide electrical conductivity between the battery modules (e.g., between the respective battery cells of the battery modules).

A battery system may also include a battery management system (BMS), which is an electronic system that is configured to manage rechargeable components of the battery system, including a rechargeable battery cell, battery module, and battery pack. For example, the BMS may protect the battery system by preventing batteries from operating outside of their safe operating area, by monitoring states of the batteries, calculating data (e.g., secondary data), reporting the data (e.g., the secondary data), controlling an environment of the batteries, authenticating the environment and/or balancing the environment. For example, the BMS may monitor the state of the battery cell as represented by voltage (e.g., a total voltage of the battery pack or battery modules, and/or voltages of individual battery cells), may monitor temperature (e.g., an average temperature of the battery pack or battery modules, coolant intake temperature, coolant output temperature, or temperatures of individual battery cells), may monitor coolant flow (e.g., flow rate and/or cooling liquid pressure), and may monitor current (e.g., electrical current).

Additionally, the BMS may calculate values based on the above characteristics or based on measured values. The measured values may include: minimum and maximum cell voltage, state of charge (SoC) or depth of discharge (DoD) to indicate the charge level of the battery cell, state of health (SoH) (e.g., a variously-defined measurement of the remaining capacity of the battery cell as a percent of the original capacity), state of power (SoP), the amount of power available for a defined time interval given the current power usage, temperature and other conditions, state of safety (SoS), maximum charge current as a charge current limit (CCL), maximum discharge current as a discharge current limit (DCL), and internal impedance of a cell (e.g., to determine open circuit voltage).

In some examples, the BMS may be centralized such that a single controller is connected to the battery cells through a multitude of wires. In some examples, the BMS may be distributed, with a BMS board installed at each cell, with just a single communication cable between the battery cell and a controller. In some examples, the BMS may have a modular construction including a few controllers, each controller handling a certain number of cells and being configured to communicate between (with other ones of) the controllers. Centralized BMSs are economical, but may be least expandable, and may be plagued by a multitude of wires. Distributed BMSs can be expensive, but can be simple to install, and may offer a clean assembly. Modular BMSs can provide a compromise of the features and problems of the other two topologies.

The BMS may protect the battery pack from operating outside of its safe operating area. Operation outside the safe operating area may be indicated by over-current, over-voltage (during charging), over-temperature, under-temperature, over-pressure, ground fault detection, and/or leakage current detection. The BMS may prevent the battery from operating outside of the safe operating parameter(s) of the battery by including a switch (e.g., an internal switch, such as a relay or a solid-state device) that opens if the battery is operated outside of its safe operating parameters. For example, the BMS may request that the devices to which the battery is connected reduce or even terminate using the battery. The BMS may control the environment (e.g., may actively control the environment). For example, the BMS may control the environment through heaters, fans, air conditioning, and/or liquid cooling.

Mechanical integration of a battery pack in a larger structure (e.g., in a vehicle) may be provided by appropriate mechanical connections between the individual components (e.g. between the individual components of battery modules) and by appropriate mechanical connections between the individual components and a supporting structure of the vehicle. These connections may be provided to remain functional and safe during the average service life of the battery system. In some applications (e.g., in mobile applications), installation space and interchangeability standards may be applicable.

Mechanical integration of battery modules may be achieved by providing a framework (e.g., a carrier framework) and by positioning (e.g., by fixing or attaching) the battery modules thereon. Fixing the battery cells or battery modules (e.g., to a framework) may be achieved by fitted depressions in the framework and/or by mechanical interconnectors such as bolts or screws. In some examples, the battery modules are confined by fastening side plates to lateral sides of the carrier framework. In some examples, cover plates may be fixed atop and/or below the battery modules.

The carrier framework of the battery pack may be mounted to a structure (e.g., a carrying structure) of the vehicle. If the battery pack is fixed at the bottom of the vehicle, the mechanical connection may be established from the bottom side of the vehicle by, for example, bolts passing through the carrier framework of the battery pack. The framework may be made of aluminum or an aluminum alloy to lower the total weight of the construction.

In some examples, battery systems, despite having any modular structure, may include a battery housing that serves as an enclosure. The enclosure may seal the battery system against the environment and provide structural protection of the battery system's components. Housed battery systems may be mounted as a whole into their application environment (e.g., in an electric vehicle).

To provide thermal control of the battery pack, a thermal management system may be employed to safely use the battery module. For example, the thermal management system may enable safe use of the battery module by efficiently emitting, discharging, and/or dissipating heat generated from the rechargeable battery cells therein. If the heat emission, discharge, and/or dissipation is not sufficiently performed (e.g., by the thermal management system), temperature deviations may occur between respective battery cells, and the battery module may not generate a desired (or designed) amount of power. In addition, an increase of the internal temperature of the battery cells may lead to abnormal reactions occurring therein, and, thus, charging and discharging performance of the rechargeable battery cells may deteriorate (e.g., may degrade) and the lifespan of the rechargeable battery cells may be shortened (e.g., may be reduced). Thus, it may be suitable to enable battery systems with cell cooling to effectively emit/discharge/dissipate heat from the battery cells.

Exothermic decomposition of cell components may lead to a “thermal runaway” (e.g., a thermal runaway event). Generally, thermal runaway describes a process (e.g., a dangerous self-reinforcing overheating process) that accelerates due to increased temperature, in turn releasing energy that further increases the temperature. Thermal runaway occurs in situations when an increase in temperature changes the conditions in a way that causes a further increase in temperature, often leading to a destructive result. For example, thermal runaway may be caused by an initial heat trigger experienced by a battery system, such as overcharging, a short circuit, external heating, and/or mechanical damage. As internal components of the battery system breakdown (e.g., become damaged) by the heat trigger, the damaged components may produce even more heat. As the temperature increases, exothermic reactions may occur. The reactions may accelerate the increase in temperature and cause further damage.

In rechargeable battery systems, thermal runaway may be associated with strong exothermic reactions that are accelerated by temperature rise. In thermal runaway, the battery cell temperature may rise (e.g., may rise incredibly fast) and the energy stored may be released suddenly. In some cases (e.g., in some extreme cases), thermal runaway can cause battery cells to explode and start a fire. In some cases (e.g., in some minor or less extreme cases), thermal runaway can cause battery cells to be damaged beyond repair.

If a battery cell is heated above a threshold temperature (e.g., a critical temperature, such as above 150°C) the battery cell can transition into a thermal runaway (e.g., may experience a thermal runaway event). Generally, temperatures outside of the safe region on either the low or high side may lead to irreversible damage to the battery cell and, therefore, may trigger thermal runaway. Thermal runaway may also occur due to an internal or external short circuit of the battery cell or due to poor battery maintenance. For example, overcharging or rapid charging may lead to thermal runaway.

During thermal runaway, a failed battery cell may reach a temperature exceeding 700°C. Further, large quantities of hot gas may be ejected (e.g., exhausted or released) as vented gas (e.g., venting products (VP)) from inside of the failed battery cell through a venting opening of the battery cell into the battery pack. Components (e.g., the main components) of the vented gas may include dihydrogen (H₂₎, carbon dioxide (CO₂₎, carbon monoxide (CO), electrolyte vapor, and other hydrocarbons. The vented gas may, therefore, be flammable and potentially toxic. The vented gas also may cause a gas-pressure to increase inside the battery pack. In some cases (e.g., in the worst case), the high temperatures may lead to the process spreading to neighboring cells and may lead to fire in the battery pack. At this stage, the fire may be difficult to extinguish.

As mentioned above, battery systems may include multiple battery cells connected in series with each other to achieve a voltage (e.g., a sufficiently high voltage) to provide a source of energy (e.g., a powerful source of energy) for propulsion of electric vehicles. In the event of a malfunction of one or more cells or voltage sources, an overheating may happen, which causes a thermal runaway of a single cell or multiple cells with generation of a hot venting gas, as well as particles and fine dust exiting the battery system and causing outside fire (e.g., causing a fire outside of the battery system. Internal measures to prevent thermal runaway, such as particle separators, may depend on an availability of space within the battery system. In some cases, sufficient space may not be available and, therefore, further (e.g., alternative precautionary) measures may be considered (e.g., may be provided). The present description of the related art section is intended to provide context only, and the disclosure of any embodiment or concept in this section does not constitute an admission that said embodiment or concept is prior art.

### SUMMARY

The present disclosure is defined by the appended claims and their equivalents. The description that follows is subject to this limitation. Any disclosure lying outside the scope of the claims and their equivalents is intended for illustrative as well as comparative purposes.

In battery systems, gases (e.g., venting products) released from batteries may lead to overheating of a given battery system, which may lead to thermal runaway (e.g., a thermal runaway event) and damage to the battery system and its surrounding environment. Directing venting products outside of the battery system may reduce the chance of thermal runaway events occurring and/or may reduce an extent of damages caused by thermal runaway events. Aspects of embodiments of the present disclosure may provide a battery system with improved ventilation and/or cooling structures and methods to reduce the risks (e.g., the dangers) of thermal runaway events.

Accordingly, according to some embodiments of the present disclosure, a battery system may include a battery pack including a housing with a floor and a plurality of battery cells accommodated within the housing above the floor, an underbody protection plate arranged below the floor, wherein the underbody protection plate and the floor are spaced apart to form an enclosed space therebetween, wherein the enclosed space includes at least one inlet fluidly connected to the housing and an outlet which leads out of the battery system, wherein the outlet is arranged (e.g., located) in a central area of the underbody protection plate, and a plurality of baffles extending between the underbody protection plate and the floor and arranged (e.g., configured), between the inlet and the outlet, to direct (e.g., to redirect) venting products exhausted by at least one of the battery cells to the outlet during a thermal runaway event (e.g., based on an initial trigger to a potential thermal runaway process).

In some embodiments of the present disclosure, an electric vehicle includes the battery system as described above.

Further aspects and features of the present disclosure can be learned from the following description and the appended claims.

### BRIEF DESCRIPTION OF THE DRAWINGS

Aspects of features of the present disclosure will become apparent to those of ordinary skill in the art by describing, in detail embodiments thereof with reference to the attached drawings.

FIG. 1 is a schematic cross-sectional view of a structure of a battery system, according to some embodiments of the present disclosure.

FIGS. 2A-2F are schematic perspective views of a structure of an underbody protection plate, according to some embodiments of the present disclosure.

FIG. 3 is a schematic top view of a structure of baffles, according to some embodiments of the present disclosure.

FIG. 4 is a schematic top view of a structure of edge areas of an underbody protection plate and a top view of an enclosed space, according to some embodiments of the present disclosure.

### DETAILED DESCRIPTION

Reference will now be made, in detail, to embodiments, examples of which are illustrated in the accompanying drawings. Aspects and features of embodiments, and implementation methods thereof, are described below with reference to the accompanying drawings.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the terms “and/or” and “or” include any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly. Herein, the terms “upper” and “lower” are defined according to the z-axis. For example, the upper cover is positioned at the upper part of the z-axis, and the lower cover is positioned at the lower part thereof.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense unless expressly so defined herein.

According to some embodiments of the present disclosure, a battery system is provided. The battery system may include a battery pack including a housing. The housing may include a floor and one or more battery cells (e.g., a plurality of battery cells) accommodated within the housing above the floor. The battery system may further include a protection plate (e.g., an underbody protection plate) arranged below the floor. In some embodiments, the protection plate may be configured to reduce (e.g., to prevent) damage to the battery system. For example, the protection plate, on its own or in conjunction with other structures, may be configured to reduce a magnitude of force(s) directed toward (e.g., against) the housing, based on the battery system being dropped or otherwise experiencing an impact. In some embodiments, the underbody protection plate and the floor are spaced apart to form a space (e.g., an enclosed space) therebetween. In other words, there may be a space (e.g., an enclosed space) between the underbody protection plate and the floor. In some embodiments, the space may be mostly enclosed (e.g., surrounded or closed off by other structures on more than half of its perimeter). In some embodiments, the space may be mostly unenclosed (e.g., mostly open, or surrounded by other structures on half or less than half of its perimeter).

In some embodiments, the space (e.g., the enclosed space) includes at least one inlet. The inlet may be fluidly connected to the housing and to an outlet which leads out of the battery system. The outlet may be located (e.g., arranged) in the underbody protection plate (e.g., may be located substantially in a central area of the underbody protection plate). For example, the outlet may be spaced apart from one or more edges of the underbody protection plate. For example, the outlet may be substantially centered with respect to two or more edges of the underbody protection plate.

In some embodiments, the battery system includes a plurality of baffles. The baffles may extend between the underbody protection plate and the floor and may be located (e.g., arranged) between the inlet and the outlet to direct (e.g., to redirect) venting products exhausted (e.g., released) by at least one of the battery cells in the event of increasing temperatures (e.g., in the event of a thermal runaway process).

In some embodiments, the battery system includes an accommodation chamber for accommodating the battery cells. For example, the battery cells may be located in the accommodation chamber. The accommodation chamber may enclose (e.g., may partially enclose or may fully enclose) the battery cells. The underbody protection plate may be located (e.g., positioned) underneath the floor. The battery system may be used (e.g., located) in a vehicle (e.g., an electric vehicle) that is used (e.g., driven) in a normal operational position (e.g., used as intended). Accordingly, “below” may refer to a z-direction (e.g., a positive z-direction that runs upwards in a vertical direction). For example, the underbody protection plate may be located below the floor such that a space (e.g., an enclosed space) is between (e.g., is built between) the floor and the underbody protection plate.

In some embodiments, the housing may include a cover (e.g., a top). The plurality of battery cells may be accommodated within the housing above the floor and below the cover. In some embodiments, each of the battery cells may include a venting side including a venting exit for allowing the venting products to exit the battery cells to a venting space or to an exhaust gas path within the housing, such that the venting products can flow into the housing in the event of a thermal runaway process occurring (e.g., being triggered). In some embodiments, the venting sides may face the cover.

In some embodiments, the plurality of battery cells may be arranged along a stacking direction, with the stacking direction running along a long side or a short side of the enclosed space. In some embodiments, the battery cells may be stacked along the stacking direction.

In some embodiments, a cooling plate may be arranged between the floor and the underbody protection plate.

In some embodiments, the space between the floor and the underbody protection plate (e.g., the enclosed space, which may also be referred to as a cavity, a clearance or a free space) may be an isolated space that may only be accessible through the inlet and outlet. In some embodiments, the enclosed space may be formed by the underbody protection plate and the floor. In some embodiments, the enclosed space may be formed by the underbody protection plate and the cooling plate.

In some embodiments, the underbody protection plate may have an edge or a plurality of edges (e.g., a plurality of connected edges) that run along the perimeter of (e.g., the circumference of) the underbody protection plate and extend in the direction of, or towards, the floor, and may be connected to the floor. In some embodiments, the underbody protection plate may have an edge or a plurality of edges (e.g., a plurality of connected edges) that run along the perimeter of (e.g., the circumference of) the underbody protection plate and extend in the direction of, or towards, the cooling plate, and may be connected to the cooling plate.

In some embodiments, one or more of the edges may include a flange that contacts the floor for joining the flange to the floor. In some embodiments, one or more of the edges may include a flange that contacts the cooling plate for joining the flange to the cooling plate.

In some embodiments, one or more inlets may be provided in (e.g., may be formed in) the underbody protection plate. For example, at least one inlet may be fluidly connected to the housing. The connection (e.g., the fluid connection) between the inlet and the housing may include a dedicated venting channel. The venting channel may be configured to direct (e.g., to redirect) venting products away from the housing. The inlet may include (e.g., may be) an opening integrated into the underbody protection plate. The inlet may include (e.g., may be) an opening integrated into the housing. The opening of the underbody protection plate may correspond to the opening of the housing to form the connection. For example, at least a portion of an opening of the housing may be located in the near (e.g., may be in fluid alignment with) the inlet (e.g., the opening) of the underbody protection plate. In some embodiments, the inlet (e.g., the opening) may include a continuous opening or a pressure vent. The pressure vent may activate when an internal pressure exceeds a threshold (e.g., a predetermined threshold), ensuring a release (e.g., a controlled release) of venting products.

The housing may include (e.g., may form) an exhaust gas path (e.g., an exhaust gas path channel or exhaust gas guide) connected (e.g., fluidly connected) to the battery cells. For example, the exhaust gas path may be fluidly connected to the venting exits of the battery cells. The exhaust gas path (e.g., the exhaust gas guide) may form one contiguous or connected (e.g., fluidically connected) space suitable for containing and directing the venting products from the battery cells to the at least one inlet. The exhaust gas path may be connected to the at least one inlet.

The exhaust gas may be provided as a safety feature that allows for gases generated during a thermal runaway to be vented (e.g., to be vented in a controlled and safe manner). By directing hot, flammable, and/or toxic gases along a predefined route, the exhaust gas path may reduce (e.g., may minimize) risks to nearby components and individuals (e.g., people) and may help reduce (e.g., avoid) secondary damage. The exhaust gas path may include features like venting valves or pressure relief openings that activate when internal pressure exceeds a threshold (e.g., a safety threshold). Exhaust gas channels may guide the escaping gases (e.g., the venting products) away from sensitive areas. For example, the exhaust gas channels may guide the venting products to an external safety zone. In some embodiments, heat-resistant materials may be used to allow the system to handle the high temperatures associated with thermal runaway events. In some embodiments, the exhaust gas path may be connected to the individual battery cells within the battery pack.

In some embodiments, each battery cell may include mechanisms, such as a venting valve or a venting opening, a pressure relief valve, or a rupture disk, that activates when internal pressure rises due to gas formation. For example, the venting valve or the venting opening, the pressure relief valve, or the rupture disk may form a venting exit of the venting side. These mechanisms may be designed to guide the escaping gases or venting products directly into the exhaust gas path.

In some embodiments, within the battery pack, battery cells may be arranged so that gases or venting products are channeled through separate internal ducts, channels, or pathways of the exhaust gas path to a central exhaust gas path. This design may prevent gases or venting products from escaping uncontrollably between battery cells and may reduce the risk of further damage or hazards. The venting valve or venting opening, pressure relief valve, or rupture disk may be fluidly connected to the exhaust gas path.

In some embodiments, the exhaust gas path may include a centralized gas collection system fluidly connected to the battery cells. For example, the centralized gas collection system may be a venting space or a venting chamber, which is used to gather gases or venting products from one or more (e.g., all) battery cells and direct them to the at least one inlet. The exhaust gas path may include separate internal ducts or pathways connected to the battery cells, such that the gases may be managed in a way that protects surrounding components and individuals (e.g., people). By connecting individual battery cells to a shared exhaust gas path, the system may mitigate the risks associated with thermal runaway, including pressure buildup, uncontrolled gas release, and thermal propagation. This integration is used in battery safety design to reduce the risk of failure (e.g., catastrophic failure).

In some embodiments, a venting space may be arranged above the battery cells of the battery pack. The venting space may be a room (e.g., a chamber) used to collect the venting products (e.g., the venting gas) from one or more battery cells (e.g., one more degassing battery cells) for subsequent distribution. The venting gas may be fed laterally (e.g., in a horizontal direction) from the venting space and then in a vertical, downward direction via the inlet into the enclosed space. For example, the venting space may be connected (e.g., fluidly connected) to the exhaust gas path or may be a part of the exhaust gas path.

The battery pack may be single-level or multi-level. For example, in a multi-level battery pack, at least two rows of battery cells are provided, with one of the two rows being arranged above the other of the two rows. For example, the battery cells may be stacked, with one row of battery cells being stacked on the other row of battery cells.

The battery system may include another battery pack. In some embodiments, the other battery pack may be arranged above the one battery pack such that the venting space may be arranged between the one and the other battery pack. This venting space may serve as a collection space for both battery packs. The venting products may be fed to the enclosed space via the inlet in the manner described above.

When the term “extending” between the underbody protection plate and the floor is used herein with regard to the plurality of baffles, it refers to the baffles having at least a geometric extension between the underbody protection plate and the floor. For example, the baffles may extend partially between the underbody protection plate and the floor, or may extend completely, such that the baffles may contact both the underbody protection plate and the floor and may connect the underbody protection plate to the floor.

In some embodiments including a cooling plate, as described above, the baffles may extend at most as far as the cooling plate (e.g., the cooling plate may serve as a limiting element), such that the baffles contact both the underbody protection plate and the cooling plate and may connect the underbody protection plate to the cooling plate.

The plurality of baffles may extend along a plane parallel to a plane defined by the underbody protection plate, in other words along an x- and/or y-direction. The baffles may have a first extension (e.g., a long extension) that runs along the x- and/or y-direction and second extension (e.g., a short extension) that runs along a vertical direction as in the z-direction. For example, the first extension of a baffle may be associated with a path having a first dimension that is greater than a second dimension of the second extension of the baffle.

In some embodiments, the plurality of baffles may be connected to (e.g., structurally connected to) the underbody protection plate or the floor. In some embodiments, including a cooling plate, the plurality of baffles may be connected to (e.g., structurally connected to) the underbody protection plate or the cooling plate.

In some embodiments, the plurality of baffles may be connected to the underbody protection plate and the floor. In some embodiments, the plurality of baffles may be connected to the underbody protection plate and the cooling plate.

The plurality of baffles may be arranged and/or may be configured in such a way that they form storage areas and/or cooling areas. The storage and cooling areas may be designed by (e.g., formed by) the arrangement and number of baffles.

Storage areas are areas within which the deposition of particles is permitted, such that a flow path for the gas (e.g., the venting products) is maintained outside the storage areas. The flow path may indicate (e.g., may include) a flow path for the venting products, such that there is a continuous flow path (e.g., a continuous free flow path) for the venting products between the inlet and the outlet.

In some embodiments, storage areas may be provided in edge areas and/or corner areas of the enclosed space. In some embodiments, storage areas may be provided in central areas (e.g., as long as a flow path to the outlet remains), such that a flow path may remain free (e.g., open) and no blockage occurs.

Edge areas may be areas that extend along a perimeter (e.g., a circumference) of the underbody protection plate or along a perimeter (e.g., a circumference) of the enclosed space. In some embodiments, the edge areas may extend less than about 30%, less than about 20%, or less than about 10% starting from each side edge of the underbody protection plate or each side edge of the enclosed space respectively towards the center of the underbody protection plate or the center of the enclosed space. The percentage ranges refer to the total lengths between opposite side edges of the corresponding component. For example, in some embodiments, the underbody protection plate, the enclosed space, and the floor (or the cooling plate) may be rectangular. In such embodiments, the edge areas may be formed by a strip extending around the above-mentioned percentage areas starting from each of the four side edges of the corresponding components. For example, an edge area may refer to an outer area of the underbody protection plate or an outer area of the enclosed space. For example, an edge area of 10% refers to an outer area of the underbody protection plate or an outer area of the enclosed space surrounding a central area of 90%.

The remaining areas enclosed by the edge areas may be referred to as the central areas or central regions.

Cooling areas are areas within which a gas flow path is extended so that the residence time of the venting products increases and a higher degree of cooling effect can be achieved. In this context, “extended” means that the venting products do not flow along the shortest direct path (e.g., the shortest direct path from their current location or a defined position to the outlet or another defined position). For example, the plurality of baffles may extend the gas flow path so that the gas flows over a greater distance, thus increasing the residence time and also increasing a flow area, which may improve heat dissipation and, as a result, may improve cooling. In some embodiments, cooling areas may be provided in a central region of the enclosed space. In some embodiments, cooling areas may be provided in edge areas or corner areas. Several cooling areas may be fluidically (e.g., fluidly) connected to each other and may form a flow path between the inlet and the outlet.

Storage areas may be areas in which turbulent flow occurs. Turbulent flows may occur when a flow of a medium is disturbed. For example, a turbulent flow may be caused by obstacles (e.g., the plurality of baffles) combined with internal friction. This phenomenon, known as the turbulence effect, may lead to chaotic and non-linear flow patterns. A turbulent flow is a movement of fluids in which turbulence occurs over a wide range of size scales. This type of flow may be characterized by a three-dimensional flow field with a component that appears to vary randomly in time and space. The turbulence may be caused by the difference in velocity of the flow at a certain distance from an overflow surface of the plurality of baffles compared to the flow near the surface of the baffles. The Reynolds number can be used to determine whether a turbulent state is present. At high Reynolds numbers, the boundary layer flow is turbulent. For this purpose, the baffles may be approximated as longitudinal overflow plates, so that a turbulent flow can be said to exist from a Reynolds number of 5*10⁵. Because a Reynolds number is a dimensionless parameter, common (e.g., all common) flow velocity measurement methods can be used to determine the Reynolds number.

In some embodiments, the plurality of baffles may be made of a material (e.g., steel) that is heat-resistant to temperatures that may occur in the case of a thermal runaway. For example, the baffles may be made of a material that is heat-resistant to temperatures above about 600° C or above about 800° C or above about 1000° C.

In some embodiments, the plurality of baffles may be plate-shaped so that they behave like an overflow plate. However, the present disclosure is not limited thereto. For example, the plurality of baffles may be convex or concave or have other shapes.

The underbody protection plate may be made of a material (e.g., steel) that is heat-resistant to temperatures that may occur in a thermal runaway. The underbody protection plate may be made of material that is heat-resistant to temperatures above about 600° C or above about 800° C or above about 1000° C. In some embodiments, cooling may be provided by outside air flowing over an underside of the underbody protection plate. As a result, heat transfer may be further improved by the turbulence in the enclosed space.

The underbody protection plate may have various shapes, for example rectangular, square, elliptical, polygonal, and/or the like.

The central area within which the outlet is located may be an area of the underbody protection plate that includes the geometric center.

During a thermal runaway of a battery cell in a battery system, hot venting products in the form of a gas containing, among other things, particles and aluminum droplets and having temperatures of about 1000°C may exit the battery cell and may be directed to the outlet of the battery system through an area that acts as a filter section to reduce (e.g., to minimize) the number of particles exiting the battery system, as well as to cool the gas so as not to cause a fire to the outside. For this purpose, hot particles may be filtered through a variety of baffles (e.g., a variety of specially arranged and configured baffles) that cause turbulence in the filter area to separate particles and gas and allow the escaping gas a longer path to cool down before leaving the battery system.

As used herein, the term “particles” refers to solid particles and liquid droplets. Furthermore, the term “gas” is used synonymously with “venting products,” “exhaust gas,” and “venting gas.”

A stream or flow of venting products (e.g., a gas stream (or an exhaust gas stream) or a gas flow (or an exhaust gas flow)), may refer to a continuous or intermittent volume or mass flow of substances released during a thermal runaway event. The flow of venting products can consist of both solid components (e.g., particles such as electrolyte residues, electrode fragments) and fluids (such as gases and liquid components).

In some embodiments, the venting products may be collected and discharged, for example, via the exhaust gas path, as discussed above. For example, the venting products may be collected and discharged via exhaust gas path channels or (at least partially) via the venting space and fed to the enclosed space acting as a separator or filter by way of the inlet. In the enclosed space, the hot particles may be cooled, partially separated, and retained and the residence time of the particles and gases may be extended in order to reduce their ignitability. In other words, means (e.g., structures, such as the plurality of baffles) may be provided to guide the venting products from the battery cells to the at least one inlet.

By increasing the turbulence, the particles may experience increased swirling. Furthermore, the particles can no longer be kept in suspension by the turbulence and may collide relatively frequently with the walls due to gravity. As a result, they may be subjected to a certain loss of momentum, which may delay their transportation. Following the baffles, there can also be an increased separation of the flow of venting products (e.g., the gas flow) within the enclosed space. For example, the flow of venting products may be combined with a negative backflow. As a result, the particles may experience a further delay and thus a separation effect.

Aspects of embodiments of the present disclosure enable a battery system having the ability to separate and store hot particles from a venting gas (e.g., during a thermal runaway event) within a filter section. The filter section may be equipped with baffles to ensure gas flow (e.g., turbulent gas flow) and to cool down the venting gas (e.g., to cool down the venting gas before the venting gas exits the battery system).

In some embodiments, the operating principle may be similar to that of mass force separation, whereby particles suspended in the gas can no longer follow the flow movement and are deposited on internals or walls. The particles may be differentiated according to the effective transport forces of gravity, inertia, and centrifugal force. The mass forces responsible for particle separation may act transversely to or against the flow resistance force and may be directly proportional to the particle mass, such that the respective forces are proportional to the third power of the particle diameter. This separation principle may be effective (e.g., particularly effective) for separating particles with an aerodynamic diameter of at least about 2 micrometers (µm). For particles of this size, the influence of diffusion can be neglected. Among other things (e.g., in addition to other types of particles), graphite particles with a size of about 1 µm to 6 µm and liquid aluminum droplets with sizes of about 1 millimeter (mm) to 3 mm may occur (e.g., may be present) in the venting products. Clumping can also occur in flow inlets up to about 10 mm.

In some embodiments, depending on their design, the baffles may act as inertial or deflection separators, in which flows are deflected, such that the particles suspended in the gas cannot follow the flow movement and are separated. For example, one or more baffles may include one or more sections (e.g., curved sections) for deflecting a flow path of the venting products. The separation of particles, droplets, or dust from flowing venting gases may take place due to the inertial force, in that the flow of fluid components of the flow of venting products within the enclosed space (e.g., the flow of fluid components of the gas flow) may be deflected by the baffles. In some embodiments, the operating principle may be based on the fact that the particles suspended in the venting gas can no longer follow a changing flow movement due to their inertia. The particles may be deposited on internals or walls or separated in enriched form in a partial flow.

In other words, in some embodiments, the battery system may provide a filtering section with baffles causing turbulent gas flow to separate particles. In some embodiments, a section in the filter systems may serve as particle storage and an elongation of the venting path to cool down the gas flow.

In some embodiments, the gas may expand and there may be lee areas (e.g., sloping areas) within the enclosed space where the particles can settle down. Even if these lee areas, for example storage areas, are full with dust, there may still remain a free path between the inlets and outlet such that the enclosed space is not clogged.

Aspects of embodiments of the present disclosure enable or increase a separation of hot particles and venting gas with high temperatures, for example, temperatures beyond (e.g., greater than or equal to) 1000° C, before exiting the system. With the further reduction of gas temperature and with no or less hot particles exiting the battery pack, the risk on outside fire may be reduced.

Due to the central arrangement of the outlet, a certain distance (e.g., a suitable or safe distance) from the outlet (in the typical arrangement of battery systems, for example, in systems or vehicles) to an area accessible to people can be maintained. For example, a battery system may only be accessed along its outer perimeter (e.g., its outer circumference), such that in the event of degassing, the gas may escape centrally below the battery pack, instead of escaping in the vicinity (e.g., the direct vicinity) of people who may be nearby.

The plurality of baffles or in other words vertical guide blades may be used to support the underbody protection plate, in the case of an underbody/bollard event. Thus, the vertical guide blades may serve as deformation structures between the underbody protection plate and the underside of the battery pack (e.g., the floor or the cooling plate).

In some embodiments, the inlet is arranged in an area of an outer perimeter (e.g., an outer circumference) of the underbody protection plate. In some embodiments, the inlet may be arranged only in an area of an outer circumference of the underbody protection plate (in case of several inlets). The edge (e.g., the rim), of the underbody protection plate may include the inlet. In embodiments having a plurality of inlets, some inlets may be provided on a first side (e.g., a first long side) of the enclosed space and some additional inlets may be provided on a second side (e.g., a second long side) opposite the first side.

Accordingly, some of the venting products can be guided out of the venting space in a different horizontal direction (e.g., in the opposite direction to the one horizontal direction), and then in a vertical, downward direction via the other inlets into the enclosed space. In some embodiments, the same number of inlets may be provided on each long side. In some embodiments, between 1 and 5, 2 and 4 or 3 inlets may be provided on each long side. By arranging the inlets in the area of the outer perimeter (e.g., outer circumference) and the outlet in the central area, there may be a sufficient flow path between the inlet and outlet to ensure cooling and separation, while at the same time maintaining a certain distance from the outlet in the typical arrangement of battery systems (e.g., in systems or vehicles) to an area accessible to people. For example, a battery system may only be accessed along its outer perimeter (e.g., its outer circumference), such that in the event of degassing, the gas escapes centrally below the battery pack and not in the direct vicinity of potentially nearby people.

In some embodiments, at least one of the plurality of baffles includes a roughened surface. For example, the roughened surface may have a surface roughness greater than about 0.5 mm. Roughness measurements of surfaces are possible in the form of (e.g., measurements may be taken or performed based on) line profiles and as planar, three-dimensional roughness measurements. The evaluation of profilometric analyses may be based on the standards Deutsches Institut fur Normung Europaishce Norm International Standardization Organization (DIN EN ISO) 4287 for line profiles and DIN EN ISO 25178 for three-dimensional roughness measurements of surfaces. The standards may also define the parameters of roughness measurements. For example, ISO 25178 defines the surface-related roughness value Sa via the arithmetic mean of the topography height z(x,y). Suitable optical measurement methods include confocal microscopy and/or the like. In some embodiments, the surface roughness value Sa may be greater than about 0.6 mm. In some embodiments, the surface roughness value Sa may be greater than about 0.8 mm. In some embodiments, the surface roughness value Sa may be greater than 1 mm. The roughness may further increase the turbulence, which may improve the deposition effect described above.

In some embodiments, a region of one or more baffles may be positioned downstream or closer to the outlet and may have a higher surface roughness than a region of the one or more baffles disposed upstream or closer to the inlet. In some embodiments, a region of one or more baffles disposed on a downstream side of the one or more baffles may have a higher roughness than a region of the one or more baffles disposed on an upstream side of the one or more baffles. In some embodiments, the one or more baffles may have a higher roughness in storage areas than in cooling areas and/or in feed areas. Such configurations of baffle surface roughness may prevent clogging of the inlet due to separation and may achieve a higher separation effect in other areas.

In some embodiments, at least one of the plurality of baffles may be arranged (e.g., positioned) such that a spin is induced into the venting products for forming a centrifugal and/or inertial separator. For example, the arrangement of one or more baffles may be configured (e.g., provided) to generate (e.g., to cause) a swirl flow like flow pattern (e.g., to cause a spin). A swirl flow is a rotationally symmetrical flow with circumferential components. As with the swirl flow in pipes, in many cases there may be an axial component of the flow velocity in addition to the circumferential component. The flowing particles then may move along helical paths and cover a greater distance along the pipe wall within a certain pipe length compared to a swirl-free flow at the same flow velocity. This may result in a greater pressure loss. Similar to a cyclone or centrifugal separator, the gas flow may be set in a rotational motion after entering the device due to its own speed. The particles suspended in the gas may be partially separated as a result of the centrifugal force acting on them. Vortex flows may occur, for example, during the flow in a cyclone. A gas flow loaded with particles (e.g. air containing dust) may enter a circular path tangentially. The particles may be thrown outwards by the centrifugal force and caught. The radial pressure difference may play a role (e.g., a significant role) here.

In some embodiments, the baffle may have a slope for inducing the spin. The slope or inclination refers to an inclined position in relation to the z-axis, so that, in addition to directional components in the direction of the x- and y-axis, a directional component is also generated in the direction of the z-axis.

In some embodiments, at least one of the plurality of baffles includes a guide element designed to impose (e.g., configured to cause) a rotational movement on a flow of the venting products (e.g., on the gas flow). In some embodiments, the guide element may be arranged (e.g., positioned) such that a spin is induced into the venting products for forming (e.g., to form) a centrifugal separator and/or an inertial separator. For example, one or more baffles may include a structural elevation, such as a ramp (e.g., as a guide element), which locally deflects the flow such that further directional components are imposed on the flow (e.g., on the gas flow). In some embodiments, one or more baffles may include a guide element, such as a ramp, to generate (e.g., to cause) a swirl flow (as discussed above). In some embodiments, the guide element may be aligned in such a way that it imposes a directional component on the flow in the z-direction (e.g., directed upwards or downwards in relation to the battery pack). In some embodiments, the guide element may be a guide vane. For example, one or more baffles may include a guide vane.

In some embodiments, the guide element may be arranged on a portion of at least one baffle that is arranged (e.g., located) closer to the inlet than to the outlet. This portion may indicate (e.g., may be positioned on) an area of the baffle that is located upstream or closer to the inlet than an area of the baffle that is located downstream or closer to the outlet and/or may indicate (e.g., may be positioned on) an area of the baffle that is located on an upstream side of the baffle. Positioning the guide element on an upstream area of a baffle may influence the flow (e.g., the gas flow) in an initial area (e.g., in an upstream area) of the baffle such that an increased (e.g., a greater) influence may be exerted on the flow.

In some embodiments, at least one pair of the plurality of baffles forms a gas flow path, for example a spiral path. The gas flow path may extend partially or completely between the inlet and outlet. In other words, a channel, flow route or flow pipe may be formed by the baffles (e.g., by a pair of baffles). For example, the two baffles may form a flow channel, flow route, or flow pipe. In some embodiments, the baffles may connect the underbody protection plate and the floor (or the cooling plate) to each other, such that a channel with a flow cross-section of a shape corresponding to the underbody protection plate and the floor or the cooling plate (e.g., a rectangular flow cross-section) is formed. In some embodiments, such a channel may have a rectangular cross-sectional area, which may be larger than about 50 mm x about 20 mm to reduce the chance of (e.g., to avoid) blockages. However, the cross-section is not limited to rectangular shapes and may also have other shapes. In some embodiments, a spiral shape may be provided to further increase separation due to inertia and centrifugal forces. In some embodiments, the baffles may have cut-outs or interruptions. According to aspects of some embodiments of the present disclosure, a gas flow path may still exist if the baffles extend more than 50% along their course and thus have less than 50% interruptions, relative to their extension along the x- and y-directions (e.g., along their respective length).

In some embodiments, the battery system may include a grid element extending between the underbody protection plate and the floor (or the cooling plate) and may be arranged between the inlet and the outlet to direct (e.g., to redirect) venting products exhausted by at least one of the battery cells in the event of (e.g., during) a thermal runaway. In some embodiments, the grid element may extend at least partially or fully between the underbody protection plate and the floor (or the cooling plate). The grid element being arranged between the inlet and the outlet can filter the venting products. In some embodiments, the grid element may be arranged between at least one pair of the plurality of baffles. Dust or particles may be deposited particularly in areas with grid-like structures. Accordingly, deposition may be enhanced by arranging such structures (e.g., the grid element) in areas where deposition is desired (e.g., not obstructive). Such areas (e.g., non-obstructive areas) may be present, for example, when a flow cross-section expands. For example, two baffles may form a flow channel, whereby the distance between the two baffles increases in the downstream direction (e.g., where the flow cross-section expands). Such an area may also be referred to as an expansion area. Grid-shaped elements may be arranged within this area (e.g., in the expansion area), such that the grid-shaped elements do not cause clogging but increase the separation and deposition of particles. Deposition may also be desirable in edge areas to allow a flow path to remain free between the inlet. Accordingly, the grid element may be arranged in edge areas and/or in storage areas.

In some embodiments, at least one of the plurality of baffles may include a curved section for deflecting a flow path of the venting products to deflect the flowing gas. Due to the inertia to which the particles are subject, the particles may accumulate in the curved area and may slow down in relation to the gas flow, resulting in improved separation of the particles.

In some embodiments, another of the plurality of baffles may be arranged downstream of the curved section of the one of the plurality of baffles such that a flow path of the venting products is divided. The curved section may cause the particles to accumulate in one part of the gas flow in a cross-section of the gas flow, such that the other baffle allows the gas flow to continue separately. One part of the gas flow then may have a higher concentration of particles and may be transported separately, for example, to storage areas, while the other part of the gas flow may have a lower concentration of particles, such that this part of the gas flow can continue independently.

In some embodiments, the curved section may have such a radius of curvature that a deflection angle of the venting products flowing through the flow path is less than about 180°, for example less than about 135° and such as less than about 100°. This may provide a suitable deflection, such that the venting products and the particles may be subjected to an inertia that enables improved separation.

In some embodiments, at least one baffle of the plurality of baffles includes surface filters and/or depth filters on their surface (e.g., one or more surface filters and/or one or more depth filters). Surface filters may be configured to separate dust particles almost exclusively on the surface of the filter. For example, a surface filter may form a layer of dust that may determine (e.g., may largely determine) the filtration performance. Contrastingly, the separated dust may be deposited inside the filter structure of a depth filter. For depth filters, the filtration properties may be determined by the internal composition of the filter. Depth filters may include a tangle of synthetic fibers, glass fibers, or even metal fibers. The diameters of the fibers may range from a few (e.g., less than 10) μm to about 50 μm. In some embodiments, nanofibers with diameters of about 0.05 µm to about 1.0 μm may be included in one or more of the baffles. In some embodiments, nanofibers may be used in combination with coarser fibers, which may improve (e.g., may ensure) the stability of the filter. The fibers may take up a few percent (e.g., a small percentage) of the filter volume. In some embodiments, distances between the fibers may be about 2 to about 10 fiber diameters and may be much larger than the particles to be separated. The separation of particles in depth filters may not, therefore, be achieved by the sieve effect. Instead, the separation processes on the individual fibers may be decisive for (e.g., may cause) the separation. The ability of a filter to cut off particles may be based on various physical and mechanical phenomena, such as diffusion, interception, inertia effect, and sieve effect. Electrostatic forces between the particles and the baffles may also play a role the ability of a filter to cut off particles (e.g., from a gas flow). Particles with a larger diameter than the enclosed space within the baffles may not pass through the filter. Larger particles have too great of an inertial force to be able to follow the gas flow when the gas flow is deflected by the baffles. For example, the particles may continue to move along their original path and stick to the upstream side of the baffles (e.g., without following the deflected gas flow). The inertia effect may increase with increasing air velocity and larger particle diameter.

In some embodiments, at least one of the plurality of baffles may include perforations. The baffle, for example in an expansion area or storage area, therefore, may have perforations that pass through the baffle (e.g., the baffle may have perforations therein) and, thus, may be a grid-shaped baffle (e.g., a grid element). For example, the baffle may be a grid-shaped element that has regular or irregular patterns of recesses or openings therein (e.g., therethrough). The grid-shaped baffle (e.g., the grid-shaped element) may cause partial gas flow and/or (e.g., combined with) the turbulence described above. The effects of the openings and deposits of particles may cause blockage, such that a completely closed baffle may be formed, which may cause complete guidance of the gas, such that, from this point, in addition to the deposition of particles, the residence time and cooling may also be improved.

In some embodiments, at least one of the plurality of baffles (e.g., at least one baffle of the plurality of baffles) includes an energy-absorbing deformation structure. For example, the baffles may have a saw blade pattern or a bellows pattern along their height (e.g., along the z-direction). As a result, the baffles may have spring properties and can absorb shocks through compression and then expand again. The energy-absorbing deformation structure, therefore, may improve the protective function of the underbody protection plate while, at the same time, improving the cooling and separating effect.

In some embodiments, an underside of the underbody protection plate may be configured to conduct heat to outside air (e.g., to air outside of the battery pack and/or the battery system). For example, the underside of the underbody protection plate may include heat transfer elements for heat conduction to outside air. The heat transfer elements may include ribs or fins and/or the like. The heat transfer elements may provide an increased surface area for the heat transfer of the venting products from the enclosed space to the environment, which may improve the cooling effect. At the same time, the heat transfer elements may improve the protective function of the underbody protection plate.

Aspects of some embodiments of the present disclosure provide for an electric vehicle that includes a battery system having aspects of some embodiments of the present disclosure.

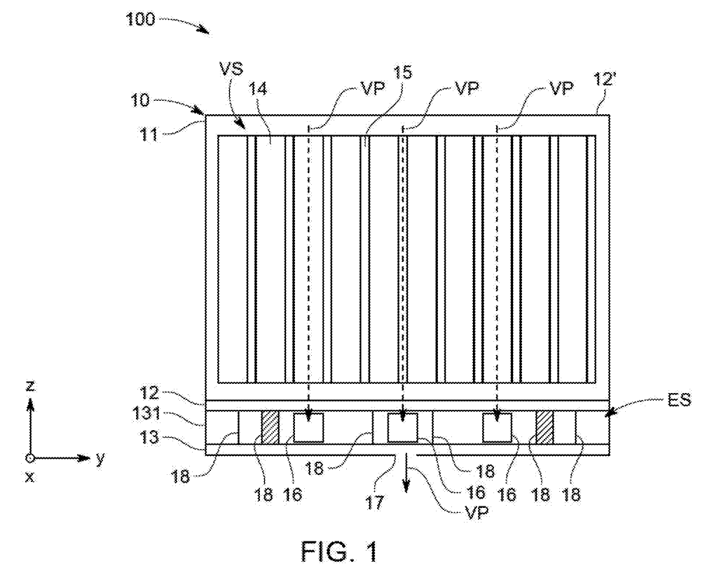

FIG. 1 is a schematic cross-sectional view of a structure of a battery system 100, according to some embodiments of the present disclosure.

Referring to FIG. 1, and as discussed above, the battery system 100 may include a battery pack 10. The battery pack 10 may include a housing 11 with a floor 12 and a cover 12’, and one or more battery cells 14 (e.g., a plurality of battery cells 14) accommodated within (e.g., at least partially located within) the housing 11 above the floor 12. Spacers 15 may be disposed between adjacent battery cells 14. A protection plate (e.g., an underbody protection plate 13) may be arranged below the floor 12 (e.g., in the z-direction), such that the underbody protection plate 13 and the floor 12 are spaced apart to form an enclosed space ES. The enclosed space ES may include one or more inlets 16 (e.g., a plurality of inlets 16) fluidly connected to the housing 11. The enclosed space ES may include an outlet 17, leading out of the battery system 100. The outlet 17 may be arranged in (e.g., located in) a central area of the underbody protection plate 13. The battery system 100 may include a plurality of baffles 18 extending (e.g., completely extending) between the underbody protection plate 13 and the floor 12. The baffles 18 may be arranged between the inlets 16 and the outlet 17 to direct (e.g., to redirect) venting products VP exhausted by at least one of the battery cells 14 in the event of (e.g., during) thermal runaway.

The spatial relativity of the structures of the battery system 100 are described herein with respect to the x-, y- and z-axes (e.g., the x-, y-, and z-directions). For example, “below”, “underneath”, “above,” and “over” may refer to the z-axis, with meanings such as “below” referring to a negative z-direction and “above” referring to a positive z-direction.

In some embodiments, a venting space VS is arranged above the battery cells 14 of the battery pack 10. The venting space VS may be a room (e.g., a space or chamber) used to collect the venting products VP from one or more degassing battery cells 14 (e.g., cells that are releasing a gas) for subsequent distribution. The venting products VP (e.g., from the gas) may then be fed laterally (e.g., in a horizontal direction) from the venting space VS and then in a vertical, downward direction, as shown by the dashed arrows, via the inlets 16 into the enclosed space ES.

The wide, flat rectangular baffles 18 depicted in FIG. 1 are intended to show schematically that the baffles 18 may run (e.g., may extend) in both the x-direction and the y-direction.

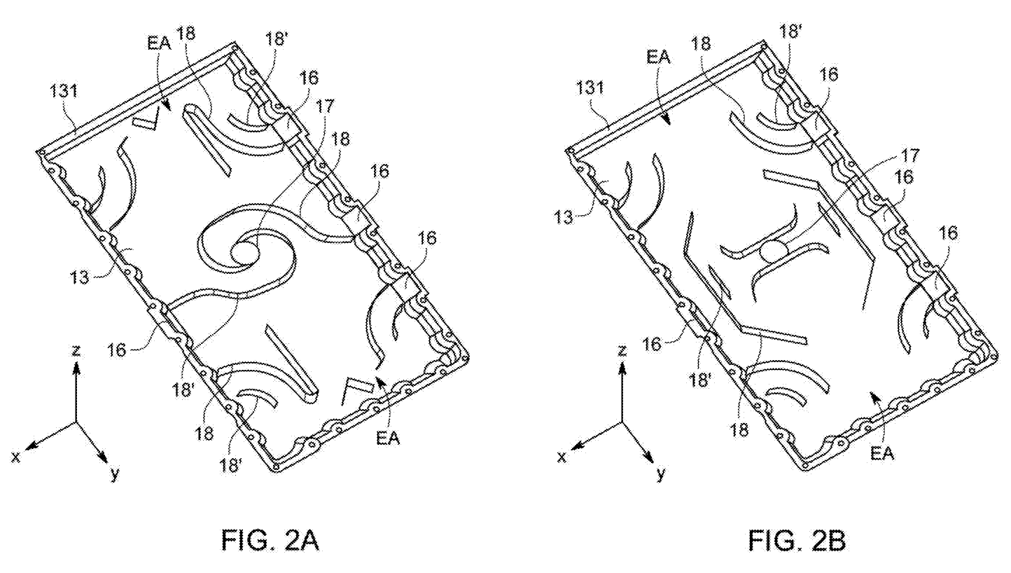

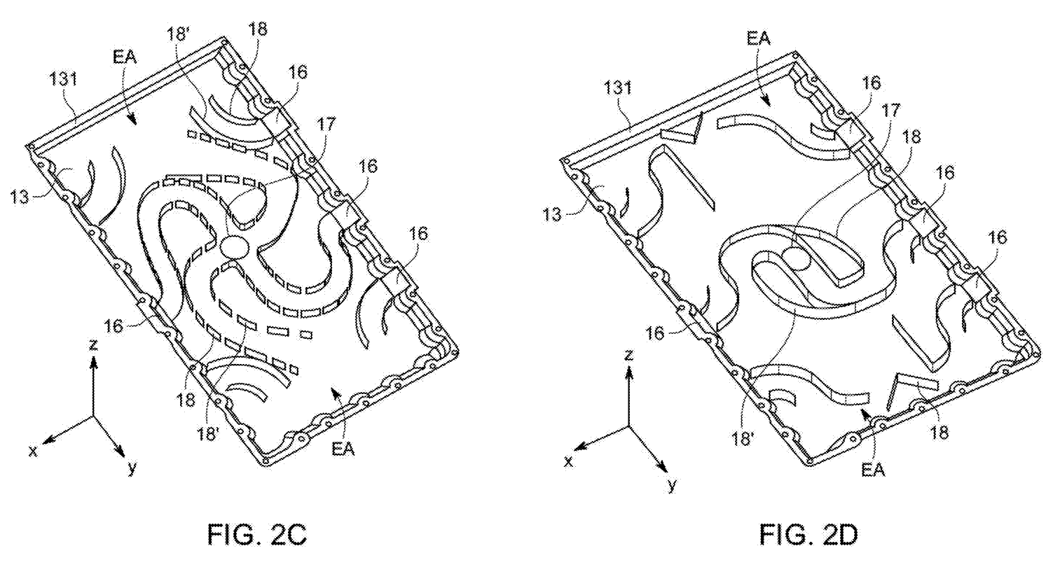

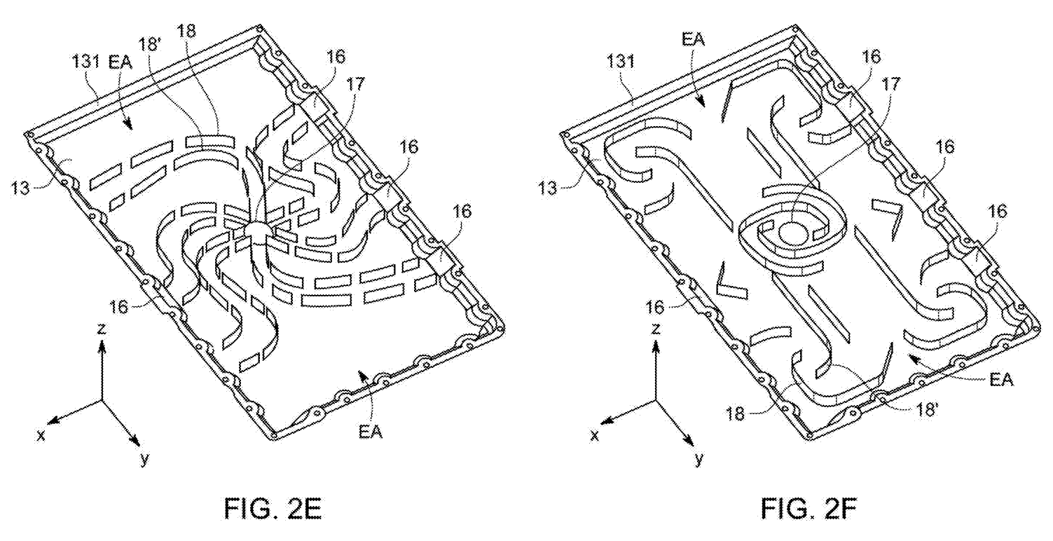

FIGS. 2A - 2F are schematic perspective views of a structure of an underbody protection plate 13, according to some embodiments of the present disclosure.

For reasons of clarity, not every single baffle 18, 18’ (e.g., baffle 18 and/or baffle 18’) is labeled with a reference symbol in the FIGS. 2A - 2F. However, it should be clear which components depicted in FIGS. 2A - 2B represent a baffle 18, 18’ (e.g., based on the labeled baffles 18, 18’).

A pair of baffles 18, 18’ (e.g., a matching pair of baffles 18, 18’), which form a flow channel, may include one baffle 18 (e.g., a first baffle of a pair of baffles) and another baffle 18' (e.g., a second baffle of the pair of baffles).

The underbody protection plate 13 may have an edge 131 that runs along its perimeter (e.g., its circumference) and extends towards the floor (see also FIG. 1) to be connected to the floor 12. The edge 131 may include a flange that contacts the floor for joining the underbody protection plate 13 with the floor 12 (e.g., to the floor 12).

In some embodiments, a number of baffles 18, 18’ (e.g., a large number of baffles 18, 18’) are provided, which extend from the underbody protection plate 13 in the z-direction (e.g., in the direction of the floor 12), which is arranged above and is not shown in FIGS. 2A - 2F. The baffles 18, 18’ may contact the floor 12 in an assembled state (see FIG. 1). The geometric dimensions (e.g., the total lengths) of each baffle in relation to the x- and y-directions may differ from one another, as may their shapes. One or more of the inlets 16 may be adjoined (e.g., fluidly connected) by at least one of the baffle 18, and/or the baffle 18 '. Inflowing venting products VP may form a turbulent flow field due to the baffles 18, 18’ while, at the same time, the area between inlets and outlets may remain free and can be flowed through (e.g., may allow gas to flow therethrough).

The plurality of baffles 18, 18’ may be connected to the underbody protection plate 13. The plurality of baffles 18, 18’ may extend along a plane parallel to a plane defined by the underbody protection plate 13, in other words along an x- and/or y-direction. The baffles 18, 18’ may have a long extension (e.g., a first extension having a first dimension) that runs along the x- and/or y-direction and may have a short extension (e.g., a second extension having a second dimension) that runs along a vertical direction (e.g., in the z-direction). In some embodiments, one or more baffles 18, 18’ may have a first dimension that is greater than the second dimension.

The plurality of baffles 18, 18’ may be arranged and/or may be configured in such a way that they form so-called storage areas and/or cooling areas. Storage areas may be provided in edge areas EA (see also FIG. 4) of the enclosed space ES.

The inlets 16 may be arranged in an area of an outer perimeter (e.g., an outer circumference) of the underbody protection plate 13. The edge 131, which may also be referred to as a rim or a flange, of the underbody protection plate 13 may include the inlets 16. In some embodiments, three inlets 16 may be provided on a first long edge of the edge 131 corresponding to a first long side of the enclosed space ES, and one inlet 16 may be provided on a second long edge of the edge 131 corresponding to a second long side opposite the first long side. For example, one long side may include more inlets 16 than an opposite long side.

Several pairs of the plurality of baffles 18 and 18’ may form a gas flow path. For example, the two baffles 18, 18’ may form a flow channel or flow route. The baffles 18, 18’ may connect to the underbody protection plate 13 and/or to the floor (or to a cooling plate). For example, the baffles 18, 18’ may connect the underbody protection plate 13 to the floor or to a cooling plate. In some embodiments, the cooling plate is arranged between the floor 12 and the underbody protection plate 13, such that a channel with a rectangular flow cross-section may be formed.

For example, and referring to FIG. 2A, a pair of baffles 18 and 18’ may be arranged in a corner area. The baffles 18, 18’ may run parallel to each other and may have a curved section, with one baffle 18 of the pair extending further than the other baffle 18 of the pair. In some embodiments, L-shaped baffles may be provided in lateral edge areas EA. Some baffles 18, 18’ may be connected to one side of a respective inlet 16 in such a way that a direct path to the outlet 17 is blocked, such that the gas flow path is increased (e.g., such that a length of gas flow via a path formed by the baffles 18, 18’ is increased).

Referring to FIG. 2B, in some embodiments, some baffles 18, 18’ may have straight sections that run parallel to the first or second long side, so that incoming gas may strike the baffles 18, 18’ (e.g., may strike the baffles 18, 18’ substantially vertically) and undergo a deflection. In some embodiments, the straight sections may be followed by a widening expansion area, from which a direct path to the outlet 17 may also blocked by baffles 18, 18’, such that a deflection may also occur near the outlet 17.

In some embodiments, as illustrated in FIG. 2C, the baffles 18, 18’ may have cut-outs or interruptions. In such embodiments, a flow path may still exist because the baffles 18, 18’ extend more than 50% along their course and thus may have less than 50% interruptions, relative to their extension along the x- and y-directions.

Further variations of the baffles 18, 18’ are depicted in FIGS. 2D - 2F. For example, referring to FIG. 2D, a flow path downstream from one or more inlets 16 may be located to divide the flow path of venting products being directed to the outlet 17. Referring to FIG. 2E, a distance between a pair of baffles 18 and 18’ may change along a given flow path. Referring to FIG. 2F, a flow path from the inlet 16 may be divided by straight sides of the baffles 18, 18’ and/or deflected by curved surfaces of the baffles 18, 18’.

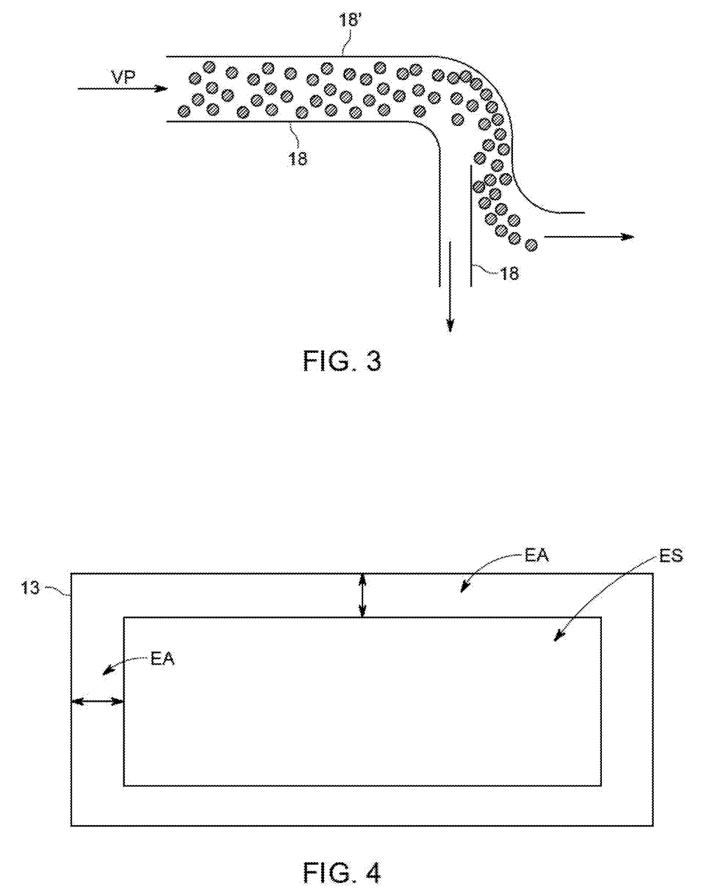

FIG. 3 is a schematic top view of a structure of baffles, according to some embodiments of the present disclosure.

Referring to FIG. 3, in some embodiments, several of the plurality of baffles 18, 18’ may further include a curved section. In some embodiments, another baffle 18 of the plurality of baffles may be arranged downstream of the curved section formed by the pair of baffles 18, 18’ such that the gas flow path is divided, as indicated by the arrows. In some embodiments, the curved section may cause the particles to accumulate in one part of the gas flow in a cross-section of the gas flow, such that the other downstream baffle 18, which divides the gas flow path, may allow the gas flow to continue separately from a path where the particles (e.g., where some or most of the particles) accumulate. In such embodiments, one part of a gas flow may have a higher concentration of particles and may be transported separately, for example, to storage areas, while the other part of the gas flow may have a lower concentration of particles, such that it can continue to flow independently from the higher concentration of particles.

FIG. 4 is a schematic top view of a structure of edge areas EA of the underbody protection plate 13 and a top view of an enclosed space ES, according to some embodiments of the present disclosure.

Referring to FIG. 4, the edge areas EA may extend along a circumference of the underbody protection plate 13. In some embodiments, the edge areas EA may extend from each side edge of the underbody protection plate 13 towards a center of the underbody protection plate 13 or the center of the enclosed space ES. In some embodiments, the underbody protection plate 13 and correspondingly the enclosed space ES may be rectangular. In such embodiments, the edge areas EA may be formed by a strip (e.g., a strip corresponding to one or more baffles 18, 18’) extending around the above-mentioned percentage areas (e.g., less than about 30%, less than about 20%, or less than about 10%) starting from each of the four side edges of the corresponding components. For example, in some embodiments, most of the baffles 18, 18’ may not be provided within the edge area EA (e.g., may mostly be provided within a central area).

### DESCRIPTION OF SOME REFERENCE SYMBOLS

100 battery system
10 battery pack
11 housing
12 floor
12’ cover
13 underbody protection plate
131 edge/flange
14 battery cell
15 spacer
16 inlet
17 outlet
18, 18’ baffle
VP venting products/gas
VS venting space
ES enclosed space
EA edge area

What is claimed is:

1. A battery system comprising:
a battery pack comprising a housing, a floor, and a plurality of battery cells within the housing above the floor;
an underbody protection plate below and spaced apart from the floor such that an enclosed space is formed between the underbody protection plate and the floor, the enclosed space comprising an inlet fluidly connected to the housing and an outlet leading out of the battery system, the outlet being in a central area of the underbody protection plate; and
a plurality of baffles extending between the underbody protection plate and the floor and being configured, between the inlet and the outlet, to direct venting products exhausted by at least one of the battery cells to the outlet.

2. The battery system as claimed in claim 1, wherein the inlet is in an outer perimeter of the underbody protection plate.

3. The battery system as claimed in claim 1, wherein at least one baffle from among the plurality of baffles comprises a roughened surface having a surface roughness greater than 0.5 millimeters.

4. The battery system as claimed in claim 1, wherein at least one baffle from among the plurality of baffles is configured to spin the venting products.

5. The battery system as claimed in claim 1, wherein at least one baffle from among the plurality of baffles forms a guide element configured to cause a rotational movement on a flow of the venting products.

6. The battery system as claimed in claim 1, wherein at least two baffles from among the plurality of baffles form a gas flow path.

7. The battery system as claimed in claim 1, further comprising a grid element extending between the underbody protection plate and the floor and configured to direct the venting products exhausted by at least one of the battery cells to the outlet.

8. The battery system as claimed in claim 1, wherein at least one baffle from among the plurality of baffles has a curved section for deflecting a flow path of the venting products.

9. The battery system as claimed in claim 8, wherein another baffle from among the plurality of baffles downstream of the curved section is configured to divide the flow path of the venting products.

10. The battery system as claimed in claim 8, wherein the curved section has a radius of curvature that causes a deflection angle of the venting products flowing through the flow path to be less than 180°.

11. The battery system as claimed in claim 1, wherein at least one baffle from among the plurality of baffles comprises a surface filter and/or a depth filter.

12. The battery system as claimed in claim 1, wherein at least one baffle from among the plurality of baffles comprises a perforation.

13. The battery system as claimed in claim 1, wherein at least one baffle from among the plurality of baffles comprises an energy-absorbing deformation structure.

14. The battery system as claimed in claim 1, wherein an underside of the underbody protection plate comprises a heat transfer element configured to conduct heat to outside air.

15. An electric vehicle comprising a battery system, the battery system comprising:
a battery pack comprising a housing, a floor, and a plurality of battery cells within the housing above the floor;
an underbody protection plate below and spaced apart from the floor such that an enclosed space is formed between the underbody protection plate and the floor, the enclosed space comprising an inlet fluidly connected to the housing and an outlet leading out of the battery system, the outlet being in a central area of the underbody protection plate; and
a plurality of baffles extending between the underbody protection plate and the floor and configured to direct venting products exhausted by at least one of the battery cells to the outlet.

16. The electric vehicle as claimed in claim 15, wherein the inlet is in an outer perimeter of the underbody protection plate.

17. The electric vehicle as claimed in claim 15, wherein at least one baffle from among the plurality of baffles comprises a roughened surface having a surface roughness greater than 0.5 millimeters.

18. The electric vehicle as claimed in claim 15, wherein at least one baffle from among the plurality of baffles is configured to spin the venting products.

19. The electric vehicle as claimed in claim 15, wherein at least one baffle from among the plurality of baffles forms a guide element configured to cause a rotational movement on a flow of the venting products.

20. The electric vehicle as claimed in claim 15, wherein at least two baffles from among the plurality of baffles form a gas flow path.
